(19) United States
(12) Patent Application Publication
(10) Pub. No.: US 2007/0131346 A1
(43) Pub. Date: Jun. 14, 2007

(54) Gliding board and method of manufacture

(76) Inventor: Bertrand Kraftt, Brison Saint-Innocent (FR)

Correspondence Address: GREENBLUM & BERNSTEIN, P.L.C., 1950 ROLAND CLARKE PLACE, RESTON, VA, 20191, US

(21) Appl. No.: 10/596,361

(22) PCT Filed: Dec. 9, 2004
(86) PCT No.: PCT/FR04/03163

§ 371 Date: Aug. 24, 2006

(30) Foreign Application Priority Data
Dec. 10, 2003 (FR) 0314444

(51) Int. Cl. B32B 38/04

(52) U.S. Cl. 156/250

(57) ABSTRACT

The invention relates to a method for manufacturing a gliding board (10), characterized in that it comprises the following distinct steps, which involve:
manufacturing a foam preform (23) of core (24) by at least one shaping step by machining;
proceeding with shaping the core (24) by thermoforming the foam preform (23) with material compression;
covering the core (24) with an outer skin (26).

### BACKGROUND OF THE INVENTION

1. Field of the Invention

The invention relates to the field of gliding boards, particularly the fields of skis, snowboards, water skis, wakeboards, surfboards, kitesurfing boards, and windsurfing boards, as well as to methods for manufacturing such gliding boards which comprise a foam core.

The invention is first described in the context of its application to a kitesurfing board, that is, a board adapted to support the user on water while being pulled by a kite, on the one hand, and to the field of skis, on the other hand.

2. Description of Background and Relevant Information

Boards for kitesurfing (also called kiteboarding) have dimensions ranging between 120 and 170 centimeters (cm) lengthwise and 30 and 60 cm widthwise, while being only a few centimeters thick.

A common method for manufacturing such boards is derived from the conventional method for manufacturing surfboards. A foam blank, made by molding, is machined (manually or by means of a digitally controlled machine) to obtain the shapes of the final core; the latter core is then covered with a skin. This skin is generally comprised of reinforcement layers (such as fiber textile) embedded in resin. One thus obtains a relatively light and rigid composite structure. Naturally, boards with very different characteristics are obtained as a function of the type of materials making up the skins, which can range from a mere sheet of thermoformed ABS resin to a composite sandwich complex, as well as glass, carbon, or Kevlar fiber composites embedded in polyester or epoxy resins.

With such a manufacturing method, the core therefore requires lengthy and complex shaping operations, as it often involves producing a three-dimensional final shape comprising essentially curved surfaces. Oftentimes, this fabricating requires a lengthy manual finishing operation of the core by planing and sanding.

It has already been proposed to mold such cores directly to the desired shape, either by injection into a mold, or by expansion in the mold. In this case, the final core is obtained in a simpler and often faster manner. However, the molding speed is relative insofar as the foam needs time to spread out inside the mold and to crosslink. Such a cycle generally requires at least ten minutes or so. During that time, the mold is made unavailable, so that if one wishes to manufacture a large number of cores, it is necessary to obtain numerous identical molds, which, in addition, requires a large area of the production unit.

Furthermore, in the two previously described manufacturing methods, one tends to obtain a core in which the foam has a substantially uniform density throughout the core. However, this is not necessarily an optimal solution.

Indeed, the characteristics and performances of a gliding board are determined as a function of its outer geometry, on the one hand, and of its various characteristics of flexional and torsional rigidity. However, in a conventional construction, these two elements are not independent. Indeed, the ends of the boards are generally thin, which makes it difficult for these two ends to be as rigid and solid as would be desirable. In addition, it is known that certain areas of the board, such as those located under the user's feet, are mechanically more biased than others. However, with a core having a uniform density, one might need to choose a dense material as a function of the forces encountered in the zones that are subjected to the greatest forces, whereas one could settle with materials having a lesser density in other zones. One is therefore led to increase the weight of the board.

Naturally, in order to avoid this, reinforcements are generally provided in these zones; but positioning these reinforcements requires additional operations and material.

Boards comprising foam cores are also found in the fields of skiing and snowboarding.

The document FR-2.622.810 describes a method for manufacturing ski cores, in which a polyurethane foam block is cut into a parallelepipedic shape, then thermoformed so as to obtain the desired thickness at each point of the ski. According to the method thus described, the final density of the core is thus variable along the ski, and in each point of the core, it is necessarily conversely proportional to the final thickness of the core at this point.

### SUMMARY OF THE INVENTION

An object of the invention is therefore to provide a new gliding board and a method for manufacturing such a board, which enables the manufacture of variable density foam cores simply and cost-effectively.

To this end, the invention provides a method for the manufacture of a gliding board, which method includes the following:
creating a foam core preform in at least one shaping phase by machining;
shaping the core further by thermoforming with material compression of the foam preform;
covering the core with an outer skin.

The invention also relates to a gliding board comprising at least one foam core covered with an outer skin, the foam core having at least one first zone and one second zone, the second zone being both thicker and denser than the first, without material discontinuity between said zones.

### BRIEF DESCRIPTION OF THE DRAWINGS

Other characteristics and advantages of the invention will be set forth in the detailed description that follows, with reference to the annexed drawings, in which:

FIGS. 1, 2, and 3 are schematic top, side, and end views, respectively, of a kite surfboard;

FIG. 4 is a side view of a rectangular foam blank;

FIG. 5 is a side view of the foam blank of FIG. 4 after having undergone a first preforming operation involving material removal thickness-wise;

FIGS. 6, 7, and 8 are schematic side, top, and end views, respectively, of the core of a kite surfboard after having undergone a shaping procedure by thermoforming with material compression;

FIG. 9 is an enlarged, partial, and cross-sectional view of the kite surfboard manufactured according to the method of the invention;

FIGS. 10 and 11 are top and side views of a second embodiment of a core preform for a board according to the invention;

FIG. 12 is a cross-sectional view of the core manufactured according to the method of the invention, from the foam preform shown in FIGS. 9 and 10;

FIG. 13 shows a ski core on which densified zones are shown according to the invention;

FIG. 15 is a schematic, partial, and cut away perspective view of a ski core with complex forms, and FIG. 14 is a similar view of a core preform that allows the core of FIG. 15 to be manufactured using a method according to the invention;

FIGS. 16 and 17 are cross-sectional views along the lines XVI-XVI and XVII-XVII of FIG. 15;

FIGS. 18 and 20 are top and transverse cross-sectional views, respectively, of a snowboard core manufactured according to the invention, and FIG. 19 is a transverse cross-sectional view of a machined core preform for manufacturing said core;

FIGS. 21 to 23 are cross-sectional schematic views showing an embodiment of the invention, in which the method allows an insert to be integrated into a foam core.

### DETAILED DESCRIPTION OF THE INVENTION

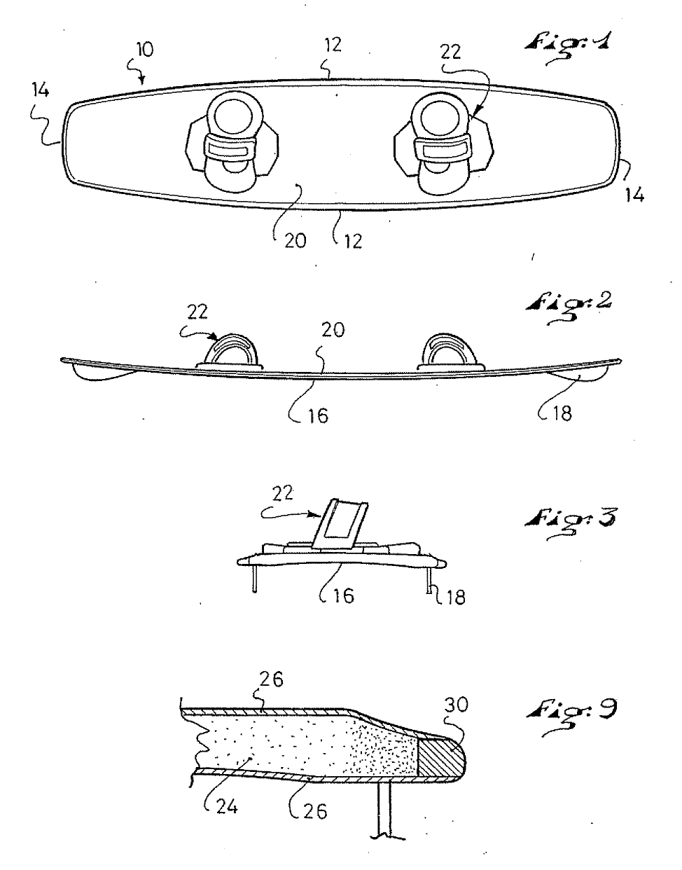

FIGS. 1 to 3 show an example of a kite surfboard 10, the outer shapes of which correspond substantially to what is commercially available. The board is substantially planar and thin. However, as shown in the side view in FIG. 2, it has a non-negligible curvature. The lateral edges 12 of the board are curved and the board also comprises curved end transverse edges 14. Preferably, the board is slightly thicker in its center than in the vicinity of its edges 12, 14. The lower surface 16 of the board, which forms the hull, has, for example, a slightly concave shape, which longitudinally extends in its center, the longitudinal edges of the hull being substantially planar.

The board is equipped with accessories such as, on its upper surface, bindings to tighten the user's feet, and on its lower surface, four fins 18 arranged in the vicinity of the four corners of the board. On the upper surface 20, also referred to as the deck, the board comprises bindings 22 in which the user can slide his feet in order to maneuver the board.

The illustrated example of a gliding board is non-limiting, and it could have another geometry or be provided with other accessories, etc.

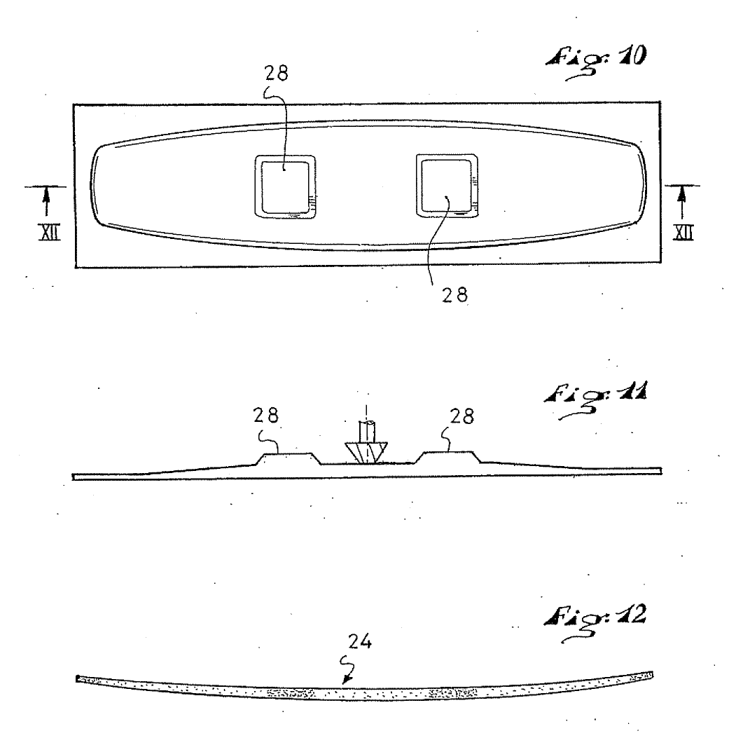

According to the teachings of the invention, and as shown in FIG. 9, the board comprises a foam core 24 that is covered with an outer skin 26, and which has zones varying in density without material discontinuity.

A principle of the invention rests on the manufacture, from a preform 23, of a foam core 24 preferably having a shape close to that of the final board, this shape being obtained prior to the core 24 being covered with the outer skin 26, and this shape being obtained by a method having at least one thermoforming procedure with material compression.

Thus, one can start, for example, from a parallelepipedic initial foam blank 21, such as shown in FIG. 4. This blank then has an initial length Lo, a width to, and a height Ho. In most cases, however, and as a function of the method for producing this initial blank, it has a relatively uniform density. Possibly, if the blank 21 is, for example, made directly by molding, it can have a surface crust having a higher density, but this crust will be substantially homogeneous over the entire surface of the blank. Preferably, one will use a thermoformable foam, for example, a PVC foam such as those marketed under the tradename “AIREX”. Other materials can be used, especially extruded polystyrene foams, and more generally all cellular materials having a synthetic resin basis.

From this rough form blank 21, a preform 23 for the core is made. Thus, in the case that is shown, a simple operation to shape the blank 21 by machining thickness-wise is provided. Therefore, the preform 23 of the core schematically shown in FIG. 5 is produced, the preform having a reduced thickness H1 in the area of its longitudinal ends. This machining operation is particularly fast and simple for because, over a given width, the thickness of the preform is constant. This machining operation can be carried out in various ways, especially by hot-wire cutting or by planing.

The preform 23 can possibly undergo other shaping operations before the procedure of thermoforming with material compression.

The thermoforming procedure according to the invention involves introducing the preform 23 of the core in the mold of a press (not shown), preferably a hot press. The preform 23 will preferably have been heated previously and brought to a temperature close to the foam thermoforming temperature. The mold will preferably have rigid surfaces.

Once in the mold, the preform is subjected to a compression force, which causes a deformation of the foam by crushing, at least in certain areas, and due to the fact that this pressure is applied at a temperature that is at least close to the thermoforming temperature, this deformation becomes permanent. Thus, after the cooling and opening of the mold, the foam will have definitively taken the shape of the core 24.

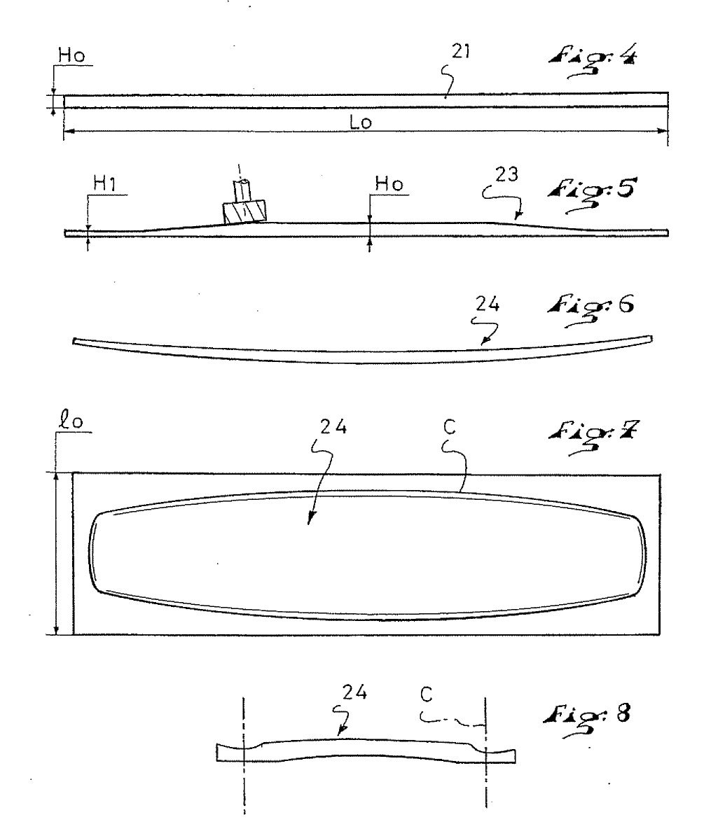

In the embodiment shown in FIGS. 6, 7, and 8, the initial foam blank 21 can be seen to have had substantially larger longitudinal and transverse dimensions than those of the core 24, such that it is necessary, after the thermoforming operation, to proceed with cutting the core 24 along its contour line C. Alternatively, one can provide for the mold of the press to be provided with sharp edges along this contour line, the cutting operation being then carried out simultaneously with that of thermoforming. One can also provide for the preform 23 to have a contour sufficiently close to that of the core, so that no cutting would be necessary.

In the example shown, the core was made in a press moveable along one direction, in this case along the direction of the thickness of the preform 23 and of the core 24. However, a mold can be used, the lateral sides of which, corresponding, for example, to the longitudinal edges of the preform, would also be transversely moveable, so that the preform would undergo a compression in two directions.

Using a PVC foam having an initial density of 80 kg/m³, this thermoforming operation can be carried out at a temperature of 80° C., at a pressure of 8 bars, for a duration of 222 seconds.

In some cases, especially when certain zones are adapted to undergo a substantial densification ratio, one can provide for the thermoforming procedure with material compression to be carried out in several gradual sub-steps, these various sub-steps using, for example, different molds, for example.

Thus, each of the various foam core areas will have been subjected to a force and a compression amplitude that is essentially dependent upon the initial thickness of the preform in this area and upon the final thickness imposed by the corresponding surfaces of the closed mold. However, tests have shown that, under the above-mentioned conditions, it is possible to locally reduce the thickness of the foam to less than a quarter of its initial thickness, that is, by multiplying its density by at least a factor of 4, without deterioration of the foam. Conversely, the foam thus densified becomes stronger in flexion and compression. Such advantages are markedly noticeable once a densification rate of about 10 to 20 percent, depending on the foam, has been reached, and are obvious at a densification rate of 100 percent, corresponding to double the initial density of the foam.

As shown in FIG. 9, a local reinforcement of the core material can thus be obtained in the area of the edges 12, 14 of the board 10, which translates into a greater strength of the edges of the boards, which are exposed to direct impacts.

In the example shown, in which the preform of the core has undergone a preliminary machining s to reduce the thickness of its ends to the thickness H1, which is less than Ho, the densification rate of the core in the area of the longitudinal ends of the board will therefore be lower than the densification ratio observed near the longitudinal edges. Thus, flexibility can be easily varied in various zones of the board. However, the entire peripheral area of the core has a higher density than that of the central area.

One must note, however, that the thermoforming procedure according to the invention may well leave some areas of the core preform completely intact, without any deformation. Likewise, it can also impart on certain areas geometrical deformations that do not lead to any noticeable material compression. Certain areas can thus be only bent by thermoforming, which, involves almost no material compression, especially for elements having a low thickness.

As shown in FIGS. 10 to 12, the invention is particularly useful in locally reinforcing areas of the board other than the peripheral area, especially the areas adapted to receive accessories such as the bindings 22 or fins 18.

Thus, one can provide that the preform of the core comprise excess thicknesses (in the compression direction provided for the shaping procedure) corresponding to the areas of the core in which one wishes to densify the foam. In the example shown, the areas of the board that are adapted to receive the bindings 20 have been chosen to be densified. Indeed, these areas of the core of the board must allow the bindings to be securely anchored, on the one hand, and to directly support the pressure forces applied by the user. It is therefore particularly advantageous to reinforce them. This is achieved in a particularly simple manner due to the invention. As shown, excess thicknesses 28 are provided in the preform, in the areas to be densified. These excess thicknesses 28 are obtained directly by molding, if the initial foam blank was obtained in this manner, or they are obtained by machining, manually (planing, sanding, etc) or with a piece of equipment (digitally controlled milling machine, etc).

After the material compression thermoforming procedure according to the invention, the core shown in FIG. 12 is indeed reinforced in the predefined areas. This local reinforcement enables the positioning of inserts in the core, which enable the anchoring of the bindings.

The same method of local densification of the core can be used, for example, to create “stiffening beams” that are directly integrated in the core, without material discontinuity. For example, if an increase in the rigidity of the board in torsion is desired, one can provide for the core to comprise diagonal beams, each connecting to two opposite corners of the board. A central longitudinal beam, which is well-known in the field of surfboard manufacturing, can thus be created in the core.

Finally, the material compression thermoforming technique can also be used to create simple, hollow and/or raised decorative designs, for example on the upper surface of the board.

Due to the invention, it is therefore possible to locally densify and reinforce the core, exactly where necessary. Contrary to certain cores of the prior art, in which local reinforcements are integrated into the form of inserts made from a different material than the base material of the core, the technology according to the invention allows the continuity of the core material between the less dense areas and the denser areas to be preserved. In addition, it is very easy to create a gradual density gradient in order to avoid sudden discontinuity of the density between the less dense areas and the denser areas. This only requires that the height variation along the edge of the excess thickness provided on the preform be gradual (as shown in FIG. 11 for the excess thicknesses 28). Areas of sudden variation of the core's mechanical characteristics are thereby avoided, which are always areas where force constraints are concentrated, and are therefore always weakened.

Shaping the core by thermoforming permits, at the same time, the outer geometrical shapes that are intended for the board, especially its thickness profile, the possible hull shapes, and/or front or rear raised spatula-shaped portions to be created. However, one can also provide for the shape of the core 24 to be corrected after the thermoforming procedure by means of a complementary operation, for example, shaping by machining, therefore by material removal.

The initial density of the foam core will naturally be selected as a function of the desired final characteristics for the gliding board, especially the desired stiffness and strength. Of course, one will also take into account the weight/volume ratio desired for the board, especially if one wishes to have specific characteristics in terms of floatability. In this context, being able to selectively densify the foam will allow preserving a low foam density in the least biased areas.

In the examples shown, the gliding board comprises only one core. However, for various reasons, the use of a plurality of cores, for example, two superimposed cores, is encompassed by the invention. Within the finished board, such two cores can be separated, for example, with a reinforcement layer such as a sheet of resin-impregnated fiber fabric, a metallic strip, etc. In any case, one can then provide that only one core be shaped according to the invention.

Once the core is made according to the teachings of the invention, the manufacture of the board can be carried out using the usual methods. All of the usual materials can be used to make the skin adapted to cover the core. This skin can have, for example, a single thermoformed ABS resin sheet, a composite sandwich complex, glass/carbon/Kevlar fiber composites embedded in polyester or epoxy resins. The skin can also include localized reinforcements, such as very high-density foams, cellular materials of the honeycomb type, etc.

As shown in FIG. 9, the board can also be provided, along its edges, with a peripheral reinforcement 30 made from plastic material, for example ABS.

It has been noticed with respect to making a kite surfboard that it could be advantageous to use a metallic reinforcement in the skin of the board. This metallic reinforcement can be, for example, a sheet of aluminum alloy with a thickness of several tenths of millimeters. This metallic sheet, which, for example, covers the upper surface of the board, is embedded in a (preferably thermosetting) resin. In order to reduce the weight thereof, one can provide that it comprises recesses, for example, holes that are regularly distributed over its entire surface.

Using these various materials adapted to form the outer skin can require subjecting the assembly to non-negligible temperatures and pressures. Tests have shown that a core made according to the invention could withstand, without any difficulty, a procedure for manufacturing the skin requiring temperatures on the order of 120° C. for durations of about 10 minutes. These conditions thus allow using all the usual materials.

The invention can also apply to boards for snowboarding, to skis in general (i.e., such as alpine skis, touring skis, cross country skis, etc), to water skis, and to wakeboards.

In the following drawing figures, various embodiments of the invention are shown in the context of other types of gliding boards.

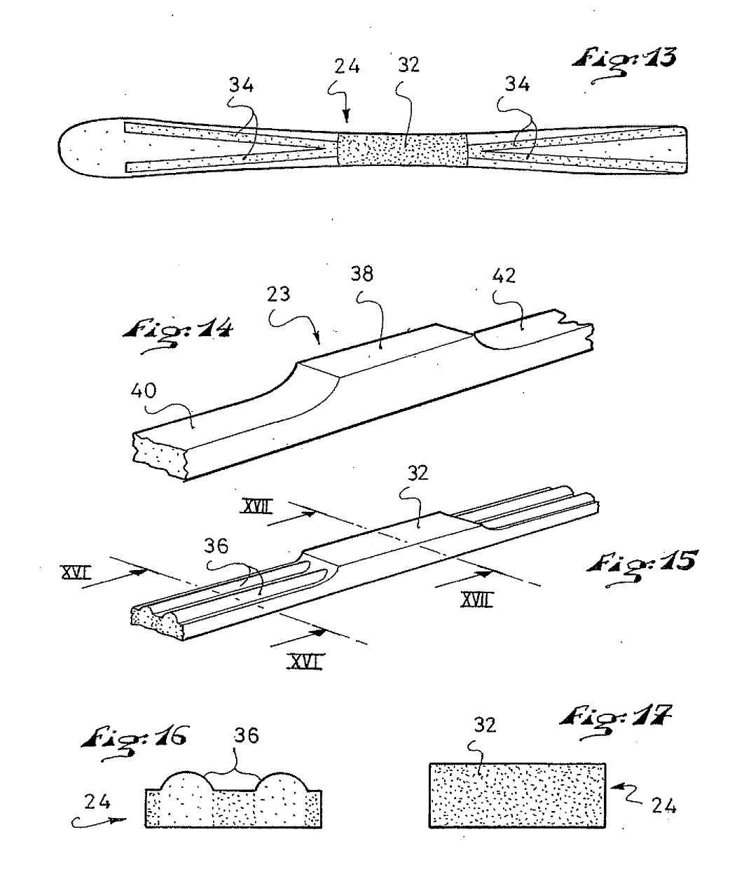

FIG. 13 shows an embodiment of the invention used to create a reinforcement of the density of a ski core 24 in its central portion 32 (or platform, the one adapted to receive the binding system), as well as in stiffened areas 34 forming an X shape, which, originating from the center of the ski core, extend in the direction of the front and rear lateral ends. In an alternative embodiment, as with the kite surfboard example, one could elect to reinforce the periphery of the core. The core in FIG. 13 is easily produced according to the invention, by machining a core preform so that it has excess thicknesses, the shape of which correspond to said zones. The final core can selectively have excess thicknesses in the area of the zones thus densified, or, conversely, a “smooth” upper surface.

FIGS. 14 to 17 show an embodiment of the invention for manufacturing a ski core 24 having a central platform 32 that is raised and densified, as well as, at the front and rear of this platform 32, two semi-cylindrical flanges 36 that extend in parallel to one another along a substantially longitudinal direction on the upper surface of the core. Such a core, schematically and partially shown in FIG. 15, can be obtained from a machined preform 23, such as shown in FIG. 14. This platform 23 has a very thick central portion 38 and, longitudinally on both sides, front 40 and rear 42 portions having a substantially rectangular section, the height of which corresponds substantially to the height of the flanges 36 of the final core. In this way, after the thermoforming procedure, the central platform 32 is very dense (FIG. 17) and the front 40 and rear 42 portions of the core are not dense in the area of the flanges 36, and are more dense between the flanges 36, as well as on both of their sides, on the lateral edges (FIG. 16). With another geometry of the machined preform, it could have also been provided that the core be conversely more dense in the area of the flanges 36 than in the adjoining areas.

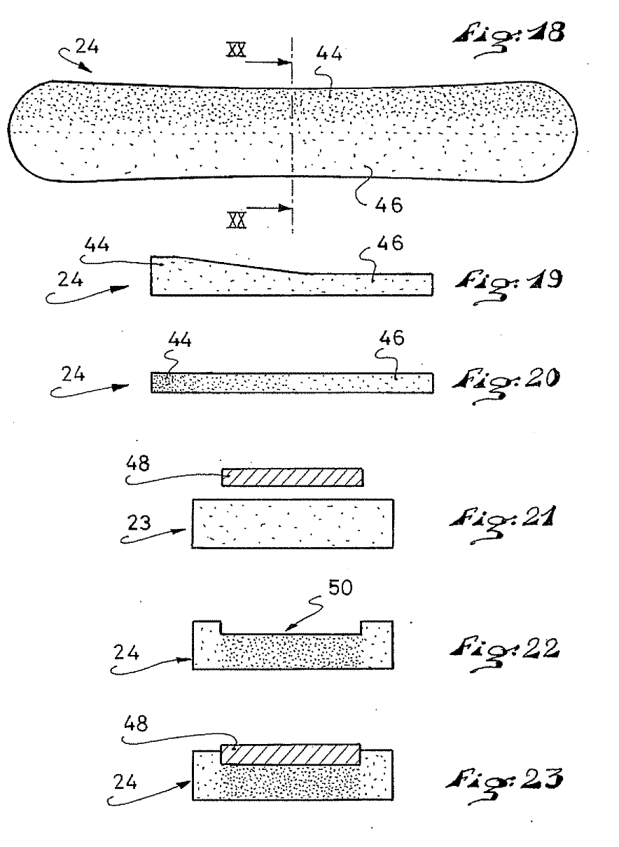

The invention can also be carried out for making a core having dissymmetrical properties. FIG. 18 shows a core 24 for a snowboard having a lateral side 44 where the foam density is higher than on the opposite lateral side 46. Due to the invention, this can be easily obtained by machining a core preform 23 having the profile shown in transverse cross-section in FIG. 19, where one side is thicker than the other. After thermoforming, a core is obtained, having, for example, a constant thickness (see FIG. 20) which has a widthwise density gradient. In the case of a core of a snowboard, the core in the area of the zones adapted for receiving the bindings can also be densified, as seen with respect to the board for kitesurfing. The lateral dissymmetry described here can, of course, be provided as a longitudinal dissymmetry, or the like.

Generally speaking, the various alternative embodiments, which have just been mentioned can be provided and used regardless of the type of gliding board envisioned, and can generally be combined together.

1-13. (canceled)

14. A gliding board comprising:
at least one core, each said core comprising a foam material:
an outer skin extending over said foam core;
said foam core comprising at least one first area and at least one second area, said one second area being both thicker and denser than said one first area;
no discontinuity of foam material between said one first area and said one second area.

15. A gliding board comprising:
at least one foam core; and
said form core having been created by a method comprising material compression thermoforming.

16. A gliding board according to claim 15, wherein:
said foam core comprising one piece of foam material, said one piece of foam material having at least one first area denser and thicker than a second area.

17. A gliding board according to claim 16, wherein:
said first area comprises a foot or boot binding area adapted to receive mounting hardware to secure the binding to the board.

18. A gliding board according to claim 17, wherein:
said at least one first denser and thicker first area comprises two longitudinally spaced apart first areas adapted to receive mounting hardware to secure longitudinally spaced apart bindings to the board.

19. A method of manufacturing a gliding board, said method comprising:
creating a core preform, said preform comprising foam material;
shaping said core preform by thermoforming said core preform to create a core, said thermoforming comprising compressing at least an area of said foam material;
covering said core with an outer skin.

20. A method according to claim 19, wherein:
said foam material is a rigid foam.

21. A method according to claim 19, wherein:
said foam material is a thermoplastic foam.

22. A method according to claim 19, wherein:
said shaping by thermoforming comprises creating areas having respective different densities.

23. A method according to claim 19, wherein:
said foam material of said core preform has an initial density;
said shaping by thermoforming compresses said foam material in said at least an area of said foam material to have a density greater than said initial density by at least 20 percent.

24. A method according to claim 19, wherein:
said foam material of said core preform has an initial density;
said shaping by thermoforming compresses a peripheral area of said core preform foam material to have a density of said core higher than said initial density.

25. A method according to claim 19, wherein:
said foam material of said core preform has an initial density;
said shaping by thermoforming compresses an area of said core preform foam material beneath an upper surface area of the board adapted to support at least one foot of the user to have a density of said core higher than said initial density.

26. A method according to claim 19, wherein:
said foam material of said core preform has an initial density;
said shaping by thermoforming preserves areas of said core preform at said initial density not subject to compression.

27. A method according to claim 19, wherein:
said foam material of said core preform has an initial density;
said shaping by thermoforming compresses at least one area of said core preform foam material to produce said core having a first area having a first density and a first thickness and a second area having a second density and a second thickness, said second density being greater than said first density and said second thickness being greater than said first thickness.

28. A method according to claim 19, wherein:
said thermoforming by compressing creates a core having a housing adapted to receive an insert.

29. A method according to claim 28, further comprising:
positioning said insert within said housing.

30. A method according to claim 28, wherein:
said thermoforming by compressing uses said insert as a tool to create said housing.
